(19) United States
(12) Patent Application Publication
(10) Pub. No.: US 2025/0056459 A1
(43) Pub. Date: Feb. 13, 2025

(54) METHOD AND APPARATUS FOR HANDLING TIMING ALIGNMENT IN WIRELESS NETWORKS

(71) Applicant: SHARP KABUSHIKI KAISHA, Sakai City (JP)

(72) Inventors: CHIE-MING CHOU, Taipei (TW); Tzu-Wen Chang, Taipei (TW); Chun-Yen Hsu, Taipei (TW); Chia-Hung Lin, Taipei (TW); Yung-Lan Tseng, Taipei (TW)

(21) Appl. No.: 18/799,831

(22) Filed: Aug. 9, 2024

Related U.S. Application Data
(60) Provisional application No. 63/532,213, filed on Aug. 11, 2023.

(51) Int. Cl. H04W 56/00; H04L 1/1812; H04W 24/10; H04W 72/21; H04W 72/231; H04W 76/28

(52) U.S. Cl. CPC H04W 56/0045; H04L 1/1812; H04W 24/10; H04W 72/21; H04W 72/231; H04W 76/28

(57) ABSTRACT

A method performed by a User Equipment (UE) for handling timing alignment is provided. The method receives, from a Base Station (BS), a first Radio Resource Control (RRC) message for configuring a Time Alignment Timer (TAT). The method receives, from the BS, a second RRC message for configuring at least one of a cell Discontinuous Transmission (DTX) operation or a cell Discontinuous Reception (DRX) operation. In a case that at least one of the cell DTX operation or the cell DRX operation is configured and the TAT expires, the method considers the UE to be uplink synchronized with the BS and forgoes performing a procedure for handling an out-of-sync condition related to the expiration of the TAT.

### CROSS-REFERENCE TO RELATED APPLICATION(S)

The present disclosure claims the benefit of and priority to U.S. Provisional Patent Application Ser. No. 63/532,213, filed on Aug. 11, 2023, entitled “TIMING ALIGNMENT HANDLING UNDER NETWORK ENERGY SAVING SCENARIO,” the content of which is hereby incorporated herein fully by reference into the present disclosure for all purposes.

### FIELD

The present disclosure is related to wireless communication and, more specifically, to a User Equipment (UE), Base Station (BS), and method for handling timing alignment in the wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the next-generation wireless communication systems.

### SUMMARY

The present disclosure is related to a UE, a BS, and a method for handling timing alignment in the wireless communication networks.

In a first aspect of the present application, a method performed by a UE for handling timing alignment is provided. The method includes receiving, from a Base Station (BS), a first Radio Resource Control (RRC) message for configuring a Time Alignment Timer (TAT); receiving, from the BS, a second RRC message for configuring at least one of a cell Discontinuous Transmission (DTX) operation or a cell Discontinuous Reception (DRX) operation; and in a case that at least one of the cell DTX operation or the cell DRX operation is configured and the TAT expires: considering the UE to be uplink synchronized with the BS; and forgoing performing a procedure for handling an out-of-sync condition related to the expiration of the TAT.

In some implementations of the first aspect, the procedure for handling the out-of-sync condition related to the expiration of the TAT includes flushing all Hybrid Automatic Repeat Request (HARQ) buffers for uplink transmission.

In some implementations of the first aspect, the procedure for handling the out-of-sync condition related to the expiration of the TAT includes notifying an RRC layer of the UE to release a configured Physical Uplink Control Channel (PUCCH).

In some implementations of the first aspect, the procedure for handling the out-of-sync condition related to the expiration of the TAT includes notifying an RRC layer of the UE to release a configured Sounding Reference Signal (SRS).

In some implementations of the first aspect, the procedure for handling the out-of-sync condition related to the expiration of the TAT includes clearing a configured downlink assignment and a configured uplink grant.

In some implementations of the first aspect, the procedure for handling the out-of-sync condition related to the expiration of the TAT includes clearing a Physical Uplink Shared Channel (PUSCH) resource for semi-persistent Channel State Information (CSI) reporting.

In some implementations of the first aspect, the TAT expires during a non-active period of the cell DTX operation or the cell DRX operation.

In some implementations of the first aspect, the method further includes suspending the TAT in response to a starting of a non-active period of the cell DTX operation or the cell DRX operation; and resuming the TAT in response to a starting of an on-duration period of the cell DTX operation or the cell DRX operation.

In a second aspect of the present application, a UE for handling timing alignment is provided. The UE includes at least one processor and at least one non-transitory computer-readable medium that is coupled to the at least one processor and that stores one or more computer-executable instructions. The computer-executable instructions, when executed by the at least one processor, cause the UE to: receive, from a BS, a first RRC message for configuring a TAT; receive, from the BS, a second RRC message for configuring at least one of a cell DTX operation or a cell DRX operation; and in a case that at least one of the cell DTX operation or the cell DRX operation is configured and the TAT expires: consider the UE to be uplink synchronized with the BS; and forgo performing a procedure for handling an out-of-sync condition related to the expiration of the TAT.

In a third aspect of the present application, a BS for handling timing alignment is provided. The BS includes at least one processor and at least one non-transitory computer-readable medium that is coupled to the at least one processor and that stores one or more computer-executable instructions. The computer-executable instructions, when executed by the at least one processor, cause the BS to: transmit, to a UE, a first RRC message for configuring a TAT; transmit, to the UE, a second RRC message for configuring at least one of a cell DTX operation or a cell DRX operation. The second RRC message enables the UE to: upon determining that at least one of the cell DTX operation or the cell DRX operation is configured and that the TAT has expired: consider the UE to be uplink synchronized with the BS, and forgo performing a procedure for handling an out-of-sync condition related to the expiration of the TAT.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1A is a timing diagram illustrating a cell DTX operation, according to an example implementation of the present disclosure.

FIG. 1B is a timing diagram illustrating a cell DRX operation, according to an example implementation of the present disclosure.

FIG. 2 is a timing diagram illustrating a TAT expiration during the cell-DTX non-active period, according to an example implementation of the present disclosure.

FIG. 3 is a flowchart illustrating a method/process performed by a UE for handling timing alignment, according to an example implementation of the present disclosure.

FIG. 4 is a flowchart illustrating a method/process performed by a BS for handling timing alignment, according to an example implementation of the present disclosure.

FIG. 5 is a block diagram illustrating a node for wireless communication, according to an example implementation of the present disclosure.

### DETAILED DESCRIPTION

Some of the abbreviations used in the present disclosure include:

### Abbreviation Full Name

3GPP 3^{rd} Generation Partnership Project
5G 5^{th} Generation
ACK Acknowledgment
BS Base Station
BWP Bandwidth Part
C-DRX Connected mode Discontinuous Reception
C-RNTI Cell RNTI
CA Carrier Aggregation
CBRA Contention Based Random Access
CC Component Carrier
CFRA Contention Free Random Access
CG Configured Grant
CHO Conditional Handover
CRC Cyclic Redundancy Check
CS-RNTI Configured Scheduling RNTI
CSI Channel State Information
CSI-RS Channel State Information-Reference Signal
DC Dual Connectivity
DCI Downlink Control Information
DG Dynamic Grant
DL Downlink
DM-RS Demodulation Reference Signal
DRB Data Radio Bearer
DRX Discontinuous Reception
DTX Discontinuous Transmission
E-UTRA Evolved Universal Terrestrial Radio Access
FDD Frequency Division Duplex
FR Frequency Range
HARQ Hybrid Automatic Repeat Request
HARQ-ACK HARQ Acknowledgement
HO Handover
ID Identifier
IE Information Element
L1/L2/L3 Layer 1/Layer 2/Layer 3
LCP Logical Channel Prioritization
LTE Long Term Evolution
MAC Medium Access Control
MAC CE MAC Control Element
MCG Master Cell Group
MCS Modulation and Coding Scheme
MN Master Node
NAS Non Access Stratum
NES Network Energy Saving
NG-RAN Next Generation RAN
NR New Radio
NUL Normal Uplink
NW Network
NZP Non-Zero Power
OFDM Orthogonal Frequency Division Multiplexing
PCell Primary Cell
PCI Physical Cell Identifier
PDCCH Physical Downlink Control Channel
PDSCH Physical Downlink Shared Channel
PHY Physical (layer)
PRACH Physical Random Access Channel
PSCell Primary SCG Cell
PTAG Primary TAG
PUCCH Physical Uplink Control Channel
PUSCH Physical Uplink Shared Channel
QCL Quasi-colocation
QOS Quality of Service
RA Random Access
RACH Random Access Channel
RAN Radio Access Network
RAR Random Access Response
Rel Release
RF Radio Frequency
RLF Radio Link Failure
RNTI Radio Network Temporary Identifier
RRC Radio Resource Control
RS Reference Signal
RSRP Reference Signal Received Power
Rx Reception
SCell Secondary Cell
SCG Secondary Cell Group
SI System Information
SIB System Information Block
SL Sidelink
SN Secondary Node
SpCell Special Cell
SPS Semi-Persistent Scheduling
SR Scheduling Request
SRS Sounding Reference Signal
SSB Synchronization Signal Block
STAG Secondary TAG
SUL Supplementary Uplink
TA Timing Advance
TAC Timing Advance Command
TAT Time Alignment Timer
TAG Timing Advance Group
TB Transport Block
TCI Transmission Configuration Indicator
TDD Time Division Duplex
TRP Transmission Reception Point
TR Technical Report
TS Technical Specification
Tx Transmission
UE User Equipment
UL Uplink
URLLC Ultra-Reliable and Low-Latency Communication
V2X Vehicle to Everything

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface. Although the gNB is used as an example in some implementations within the present disclosure, it should be noted that the disclosed implementations may also be applied to other types of base stations.

The BS may be operable to provide radio coverage to a specific geographical area using multiple cells forming the RAN. The BS may support the operations of the cells. Each cell may be operable to provide services to at least one UE within its radio coverage.

Each cell (may often referred to as a serving cell) may provide services to one or more UEs within the cell's radio coverage, such that each cell schedules the DL (and optionally UL resources) to at least one UE within its radio coverage for DL (and optionally UL packet transmissions from the UE). The BS may communicate with one or more UEs in the radio communication system via the cells.

A cell may allocate sidelink (SL) resources for supporting the Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As discussed above, the frame structure for NR may support flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes may be considered for NR, specifically, Low-Density Parity-Check (LDPC) code and Polar Code. The coding scheme adaption may be configured based on channel conditions and/or service applications.

At least the DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Network Energy Saving (NES) is an imperative requirement for the cellular networks. Recently, the 3GPP has tried to specify time domain solutions where the Next Generation Node B (gNB) may power ON/OFF its transceiver or hardware module based on specific time patterns for saving the power consumption. The concepts of cell-DTX and cell-DRX have been introduced. A periodic cell DTX/DRX configuration may be explicitly signaled to the UEs. The cell DTX/DRX configuration may include at least one of the following parameters: the periodicity (which may also be called the cell DTX/DRX cycle), the start offset, the slot offset, and the on-duration.

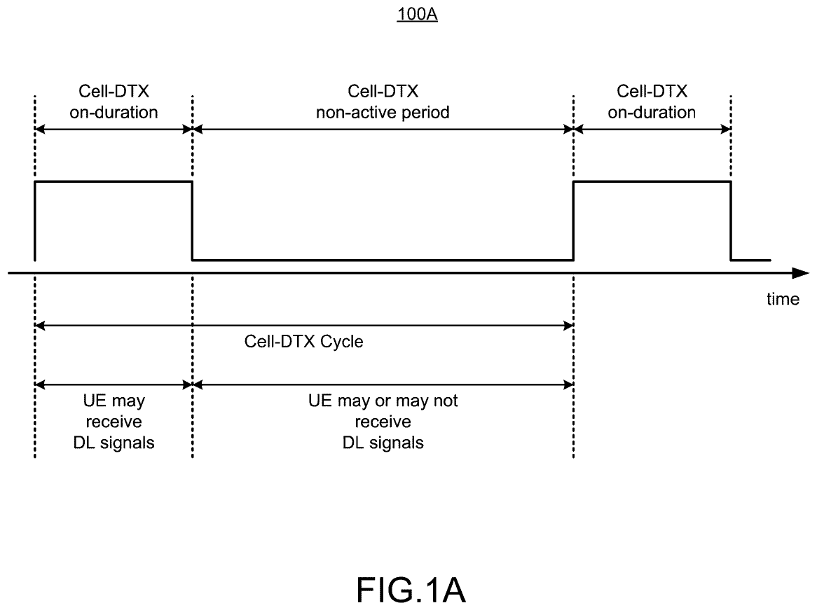

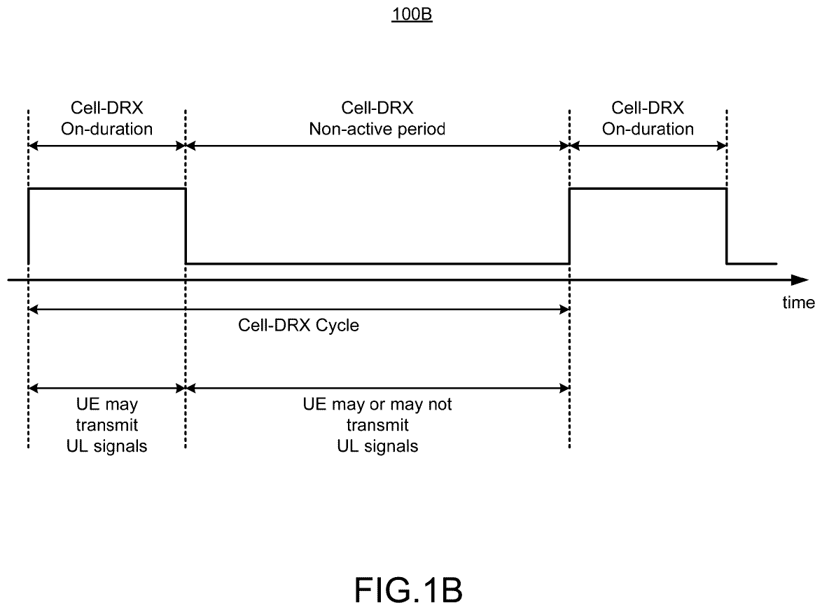

FIG. 1A is a timing diagram 100A illustrating a cell DTX operation, according to an example implementation of the present disclosure. The base station (e.g., the gNB) may perform legacy behaviors during the cell-DTX on-duration (may also be referred to as the cell-DTX active period) to schedule/transmit DL signals/packets to the UE. The UE may receive DL signals during the cell-DTX on-duration. On the other hand, during the cell DTX non-active period, the base station may not schedule the UE-specific dynamic grants/assignments, even if the UE is in the C-DRX active time. The UE may not monitor the PDCCH for receiving dynamic grants/assignments for new transmissions during the cell DTX non-active period, even if the UE is in the C-DRX active time. A cell-DTX cycle may include the cell-DTX on-duration and the cell-DTX non-active period.

FIG. 1B is a timing diagram 100B illustrating a cell DRX operation, according to an example implementation of the present disclosure. The UE may transmit UL signals during the cell-DRX on-duration (may also be referred to as the cell-DRX active period). On the other hand, during the cell-DRX non-active period, the UE may not transmit at the CG occasions or SR occasions. For example, the SR transmission may be dropped during the cell DRX non-active period. A cell-DRX cycle may include the cell-DRX on-duration and the cell-DRX non-active period.

In some implementations, the ON/OFF behavior of the BS may be activated when the configuration (e.g., the cell-DTX or cell-DRX configuration) is configured. In some implementations, the ON/OFF behavior of the BS may be deactivated when the configuration (e.g., the cell-DTX or cell-DRX configuration) is released. In some implementations, a random access procedure (e.g., a CBRA procedure or a CFRA procedure) may not be affected by the activation of the cell DTX operation or the cell DRX operation.

Timing Advance (TA) is a special command (or notification) from the base station (e.g., the gNB) to the UE to enable the UE to adjust its uplink transmission. The UE may determine the TA value from different MAC commands (depending on the different conditions) received from the base station. In some implementations, the UE may apply the TA value extracted from a RAR. In some implementations, the UE may apply the TA value extracted from a Timing Advance Command (TAC) MAC CE if the UE receives it. The base station may provide the UE with a configurable timer, also referred to as the Time Alignment Timer (TAT), to control how long the UE may be considered as plink time aligned. The value of the TAT may depend on the UE's speed and the channel condition. For example, the value of the TAT may include: 500 ms, 750 ms, 1280 ms, 1920 ms, 2560 ms, 5120 ms, 10240 ms, and infinity. Before the TAT expires, the UE may consider itself to be in the uplink synchronization state. After the TAT expires, the UE may consider itself to be in the uplink out-of-synchronization (which may also be referred to as “out-of-sync”) state.

In some implementations, upon receiving the TAC, the UE may start or restart the TAT and may be considered as uplink synchronized. Before the TAT expires, the UE may be permitted to perform UL transmission via a dynamic grant (DG) or CG. When the TAT expires, the UE (e.g., the MAC entity of the UE) may assume that the UE is out of uplink synchronization and perform a procedure for handling an out-of-sync condition related to the expiration of the TAT. The procedure for handling the out-of-sync condition may include at least one of the following operations: flush all the HARQ buffers (of the UE), notify the RRC layer (of the UE) to release a configured PUCCH, notify the RRC layer (of the UE) to release a configured SRS, clear any configured downlink assignment and CG (at the UE side), and clear any PUSCH resource for semi-persistent CSI reporting (at the UE side).

The expiration of the TAT may impose a significant burden on the UE and the base station. If the cell DTX operation or the cell DRX operation is configured, the expiration of the TAT may take place during the cell-DTX/cell-DRX non-active period. This may happen because the base station may not provide any TAC in the cell-DTX/cell-DRX non-active period. Some of the implementations provided in this disclosure may eliminate the aforementioned overhead and burden which is caused due to the expiration of the TAT under/during the cell DTX operation or the cell DRX operation. The cell DTX operation may also be referred to as “cell-DTX” or “cell DTX”, and the cell DRX operation may also be referred to as “cell-DRX” or “cell DRX” in the present disclosure.

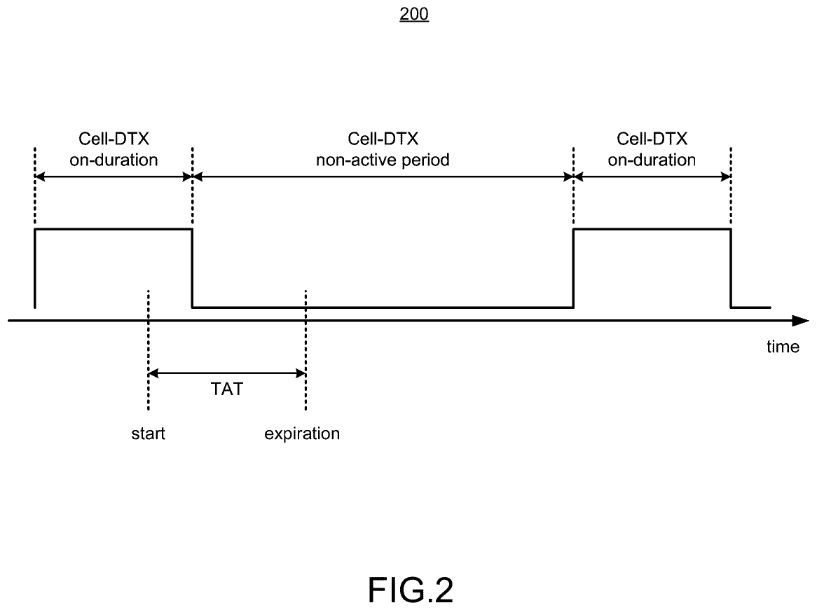

FIG. 2 is a timing diagram 200 illustrating a TAT expiration during the cell-DTX non-active period, according to an example implementation of the present disclosure. The UE may receive a TAC in the cell-DTX on-duration period and start the TAT. Because the cell-DTX non-active period is longer than the configured TAT, the TAT may expire during the cell-DTX non-active period. As a result, the base station and the UE may be required to perform TA adjustment in every cell-DTX on-duration period and the base station may also be required to provide the relevant configurations.

Some implementations for handling the expiration of the TAT (e.g., during the cell-DTX/cell-DRX non-active period) are disclosed below. It should be noted that although the cell DTX operation is used as an example, the disclosed implementations may be applied to the cell DRX operation as well. For example, a specific action performed at the start of the cell-DTX non-active period may also be performed at the start of the cell-DRX non-active period. Suspend the TAT while entering the cell-DTX/cell-DRX non-active period

In some implementations, the UE may suspend the TAT in response to a starting of a non-active period of the cell-DTX/cell-DRX operation. For example, the UE may suspend the running of TAT at the first symbol of the cell-DTX/cell-DRX non-active period. In some implementations, the UE may resume the TAT in response to a starting of an on-duration period of the cell-DTX/cell-DRX operation. For example, the UE may resume the running of the TAT at the first symbol of the cell-DTX/cell-DRX on-duration period.

In some implementations, when the TAT is suspended and then resumed during the next cell-DTX on-duration period, and is subsequently expired, the UE may perform the procedure for handling the out-of-sync condition related to the expiration of the TAT (e.g., flushing the HARQ buffers). When the TAT is suspended, the UE may not perform the procedure for handling the out-of-sync condition related to the expiration of the TAT.

Even if the TAT expires, the UE may still be permitted to transmit UL signaling/data during the cell-DTX/cell-DRX on-duration period when one of the following conditions is met:
upon receiving a TAC from the base station.
upon receiving a PDCCH order to trigger the RA and obtaining the corresponding TA in the RAR.
upon triggering a CBRA procedure and obtaining the corresponding TA in the RAR. In some implementations, the UE may consider the CBRA procedure as complete upon receiving the TA, without relying on a contention resolution process.

In some implementations, the base station may provide an indicator for indicating whether the suspension of the TAT is enabled or not. The indicator may be included in the cell-DTX/cell-DRX configuration, but not limited thereto. For example, the indicator may also be provided in another configuration.

In some implementations, the indicator for indicating whether the suspension of the TAT is enabled or not may be an implicit indication. For example, the suspension of the TAT may be enabled/disabled when the UE is under a dormancy BWP, when the UE's transmission power exceeds a first threshold, or when the UE's TA value exceeds a second threshold.

In some implementations, if the UE performs a random access procedure during a cell-DTX/cell-DRX non-active period, the TAT may be restarted and may not be suspended in the subsequent cell-DTX/cell-DRX no-active periods during the random access procedure.

Apply New Behaviors when the TAT Expires

In some implementations, in a case that at least one of the cell DTX operation or the cell DRX operation is configured and the TAT expires, the UE may still consider itself to be uplink synchronized with the BS and may forgo performing a procedure for handling an out-of-sync condition related to the expiration of the TAT. In other words, the UE may not perform the procedure for handling the out-of-sync condition related to the expiration of the TAT. The UE may apply at least one of the following “new behaviors” when the TAT expires:
The UE may not flush all the HARQ buffers for uplink transmission. Because the HARQ buffers are not flushed, the UE may perform the retransmission in the next cell-DTX/cell-DRX on-duration period when the TAT is started or restarted.
The UE may not notify the RRC layer of the UE to release a configured PUCCH or a configured SRS. The UE may assume that these configurations (e.g., the PUCCH or the SRS) are still valid. In some implementations, when the TAT expires, these configurations may be suspended and may be valid only when the TAT is started or restarted.
The UE may not clear any configured downlink assignment and configured CG. The UE may be permitted to receive/transmit via these resources (e.g., the configured downlink assignment and configured CG) when the TAT is started or restarted.
The UE may not clear any PUSCH resource for semi-persistent CSI reporting. The UE may be permitted to transmit CSI reporting when the TAT is started or restarted.

The “new behaviors” listed above may be applied separately or jointly. For example, when a specific new behavior, as listed above, is not applied, the UE may follow a corresponding legacy behavior. The new behaviors listed above may be applied when the cell-DTX/cell-DRX is configured, regardless of whether the expiration of the TAT takes place in the cell-DTX/cell-DRX on-duration period or the cell-DTX/cell-DRX non-active period.

In some implementations, the base station may provide an indicator for indicating whether the new behaviors, as listed above, are applied or not. The indicator may be included in the cell-DTX/cell-DRX configuration, but not limited thereto. For example, the indicator may also be provided in another configuration.

The indicator may be a 1-bit indicator to specify whether the new behaviors are applied or not. The indicator may be a bitmap in which each bit represents whether a specific new behavior is applied or not. The indicator may be a variable where different entries or values represent various patterns of applying the new behaviors.

In some implementations, the indicator for indicating whether the new behaviors are applied or not may be an implicit indication. For example, the new behaviors may (or may not) be applied when the UE is under a dormancy BWP, when the UE's transmission power exceeds a first threshold, or when the UE's TA value exceeds a second threshold.

In some implementations, the start/restart of the TAT may be used as a condition to determine whether the uplink synchronization is achieved during the new behavior operation. Other conditions may include, but are not limited to, the following:
when a (2-step/4-step) CBRA or CFRA procedure is performed and successfully completed;
when a TAC is received;
when any RRC configuration/reconfiguration is performed (e.g., a handover command); and/or
when particular services are triggered.

### Other Operations Performed by the BS or UE

In some implementations, if the BS (e.g., gNB) is aware that the TAT will expire during the cell-DTX/cell-DRX non-active period, the BS may allocate a PDSCH/PUSCH resource, the occasion of which may be during the cell-DTX/cell-DRX non-active period, to provide an opportunity for performing an uplink synchronization process. Such an operation may be referred to as “exception handling” with respect to the expiration of the TAT, because the BS may still transmit/receive data during the cell-DTX/cell-DRX non-active period. For example, the BS may inform the UE of when the BS will “wake up” during the upcoming cell-DRX non-active period by allocating a PUSCH resource to the UE. The TAT may be restarted when the UE transmits data on this PUSCH resource, thereby preventing the TAT from expiring.

In some implementations, the BS may use a specific CG configuration to allocate the corresponding resource, which may also be referred to as a specific CG resource. The specific CG resource may be associated with the cell-DTX/cell-DRX configuration and may not be prohibited for this purpose (e.g., for the exception handling).

In some implementations, the BS may provide a PDCCH order (e.g., for triggering an RA procedure) and the UE may be allowed to perform a CFRA procedure during the cell-DTX/cell-DRX non-active period.

In some implementations, if the UE is aware that the TAT will expire during the cell-DTX/cell-DRX non-active period, the UE may initiate an RA procedure before the expiration of the TAT.

In some implementations, the UE may be indicated (e.g., by receiving an indication from the BS) to perform such an operation (e.g., initiating an RA procedure) if the UE is configured with the cell-DTX/cell-DRX by the BS. In some implementations, whether such an operation is enabled or not may depend on the UE's implementation. For instance, in a case that the UE is configured with the cell-DTX/cell-DRX, the UE may either be instructed nor required to perform the RA procedure if the TAT expires during the cell-DTX/cell-DRX non-active period.

In some implementations, when the TAT is going to expire, the UE may perform the RA procedure, as described above, but may not flush the HARQ buffers or release the RRC configuration until the RA procedure has been successfully completed.

In some implementations, if the UE is aware that the TAT will expire during the cell-DTX/cell-DRX non-active period, the UE may perform a cell selection procedure (e.g., to transition to an RRC IDLE state) and try to camp on another cell even though the cell quality of the current serving cell might still be satisfactory.

The operations described above, including initiating an RA procedure and performing a cell selection procedure, may be referred to as “exception handling” performed by the UE with respect to the expiration of the TAT.

In some implementations, the base station may provide an indicator for indicating whether the “exception handling” is enabled or not. The indicator may be included in the cell-DTX/cell-DRX configuration, but not limited thereto. For example, the indicator may also be provided in another configuration.

In some implementations, the indicator for indicating whether the “exception handling” is enabled or not may be an implicit indication. For example, the “exception handling” may be enabled/disabled when the UE is under a dormancy BWP, when the UE's transmission power exceeds a first threshold, or when the UE's TA value exceeds a second threshold.

### Set the TAT to a Specific Value Upon Entering the Cell-DTX/Cell-DRX Non-Active Period

In some implementations, the UE may set the TAT to a new value (e.g., a specific value configured or pre-defined by the BS) at the first symbol of the cell-DTX/cell-DRX non-active period. After the TAT is set to the new value, the UE may follow legacy behaviors for handling the out-of-sync condition (e.g., flushing HARQ buffers or releasing a configured PUCCH) when the TAT with new value expires (e.g., during the cell-DTX/cell-DRX non-active period).

In some implementations, the specific value may be a default value. In some implementations, the specific value may be infinity, and therefore the TAT may not expire anymore (e.g., during the cell-DTX/cell-DRX non-active period). In some implementations, the TAT may continue running during the next cell-DTX/cell-DRX on-duration period.

In some implementations, the UE may add an offset to the TAT and thus extending the TAT to a new value. The offset may be configured or pre-defined by the BS. The offset may include a default value. In some implementations, the TAT (e.g., the extended TAT) may continue running during the next cell-DTX/cell-DRX on-duration period.

The UE may transmit the UL signals during the cell-DTX/cell-DRX on-duration period if the TAT with the new value does not expire. For example, the UE may assume that the uplink synchronization is kept/controlled by the TAT even if the TAT is set to a specific value or has an offset added.

### Set the TAT Value to a Specific Value Upon Receiving the Cell-DTX/Cell-DRX Configuration

In some implementations, the UE may set the TAT to a new value (e.g., by setting the TAT to a specific value or adding an offset to the TAT) when the UE receives the cell-DTX/cell-DRX configuration (e.g., when the cell-DTX/cell-DRX is activated).

The UE may set the TAT to infinity upon receiving the cell-DTX/cell-DRX configuration. The TAT may be implicitly deactivated when the UE applies an NES scheme.

The TAT with the new value may not be reset when the cell-DTX/cell-DRX configuration is released.

The UE may transmit the UL signals during the cell-DTX/cell-DRX on-duration period if the TAT with the new value does not expire. For example, the UE may assume that the uplink synchronization is kept/controlled by the TAT even if the TAT is set to a specific value or has an offset added.

Table 1 below illustrates a procedure for handling the TAT under the NES scheme, according to an example implementation of the disclosure.

TABLE 1

| | |
|---|---|
| (a) | The UE may perform a cell selection procedure and an RA procedure to complete the |
| | DL and UL synchronization with a serving cell. |
| (b) | The UE may perform capability negotiation with the network. The UE may indicate to |
| | the network that the UE supports the cell-DTX and cell-DRX feature with a new TAT |
| | handling mechanism. |
| (c) | Upon receiving the TA value in the RAR, the UE may start the TAT. The UE may restart |
| | the TAT upon subsequently receiving a TAC during the services. |
| (d) | The BS may configure cell-DTX/cell-DRX via RRC signaling to the UE and indicate to |
| | the UE to enable UE to apply the new TAT handling mechanism. |
| (e) | When the TAT expires during the cell-DTX/cell-DRX non-active period, the UE may |
| | perform at least one of the following operations: flush all HARQ buffers, suspend the |
| | configured PUCCH and SRS, clear any configured downlink assignment and CG, and |
| | suspend any PUSCH resource for semi-persistent CSI reporting. |
| (f) | When the TAT expires and the UE enters the cell-DTX/cell-DRX on-duration period, |
| | the UE may not be allowed to transmit CSI reporting and UL signals, except for the RA |
| | preamble, unless the UE receives a TAC MAC CE. |
| (g) | Upon receiving the TAC MAC CE, the suspended configuration may be validated and |
| | the UE may perform legacy behaviors afterwards. |

Table 2 below illustrates a procedure for maintaining the uplink time alignment under the cell-DTX/cell-DRX operation, according to an example implementation of the disclosure. The N_{TA} in Table 2 below is the value of the timing advance, as described in the 3GPP TS 38.211 V17.5.0.

```
TABLE 2
1> when a timeAlignmentTimer expires:
  2>  if the timeAlignmentTimer is associated with the PTAG:
    3>  flush all HARQ buffers for all Serving Cells;
    3>  notify RRC to release PUCCH for all Serving Cells, if configured;
    3>  notify RRC to release SRS for all Serving Cells, if configured;
    3>  clear any configured downlink assignments and configured uplink grants;
    3>  clear any PUSCH resource for semi-persistent CSI reporting;
    3>  consider all running timeAlignmentTimers as expired;
    3>  maintain N_{TA} of all TAGs.
  2>  else if the timeAlignmentTimer is associated with an STAG, then for all Serving
  Cells belonging to this TAG:
    3>  flush all HARQ buffers;
    3>  notify RRC to release PUCCH, if configured;
    3>  notify RRC to release SRS, if configured;
    3>  clear any configured downlink assignments and configured uplink grants;
    3>  clear any PUSCH resource for semi-persistent CSI reporting;
    3>  maintain N_{TA} of this TAG.
1>  when a timeAlignmentTimer expires and the cell-DTX/cell-DRX is configured:
  2>  if the timeAlignmentTimer is associated with the PTAG and expires during the cell-
  DTX/cell-DRX non-active period:
    3>  flush all HARQ buffers for all Serving Cells;
    3>  notify RRC to suspend PUCCH for all Serving Cells, if configured;
    3>  notify RRC to suspend SRS for all Serving Cells, if configured;
    3>  clear any configured downlink assignments and configured uplink grants;
    3>  suspend any PUSCH resource for semi-persistent CSI reporting;
    3>  consider all running timeAlignmentTimers as expired;
    3>  maintain N_{TA} of all TAGs.
  2>  else if the timeAlignmentTimer is associated with the PTAG and expires during the
  cell-DTX/cell-DRX on-duration period:
    3>  flush all HARQ buffers;
    3>  notify RRC to release PUCCH, if configured;
    3>  notify RRC to release SRS, if configured;
    3>  clear any configured downlink assignments and configured uplink grants;
    3>  clear any PUSCH resource for semi-persistent CSI reporting;
    3>  maintain N_{TA} of this TAG.
```

A group of serving cells that is configured by the RRC signaling and that, for the cells with a UL configured, use the same timing reference cell and the same Timing Advance value may be referred to as a timing advance group. A Timing Advance Group including the SpCell of a MAC entity may be referred to as a Primary Timing Advance Group (PTAG), whereas the term Secondary Timing Advance Group (STAG) may refer to the other TAGs.

When the MAC entity stops the uplink transmissions for an SCell, due to the fact that the maximum uplink transmission timing difference between the TAGs of the MAC entity or the maximum uplink transmission timing difference between the TAGs of any MAC entity of the UE is exceeded, the MAC entity may consider the timeAlignmentTimer associated with the SCell as expired.

In some implementations, the MAC entity may not perform any uplink transmission on a serving cell except the random access preamble and MSGA transmission when the timeAlignmentTimer associated with the TAG to which this serving cell belongs is not running. In some implementations, when the timeAlignmentTimer associated with the PTAG is not running, the MAC entity may not perform any uplink transmission on any serving cell except the random access preamble and MSGA transmission on the SpCell. In some implementations, the MAC entity may not perform any uplink transmission on a serving cell if the TAT (e.g., the timeAlignmentTimer) expires during the cell-DTX/cell-DRX non-active period except the random access preamble and MSGA transmission.

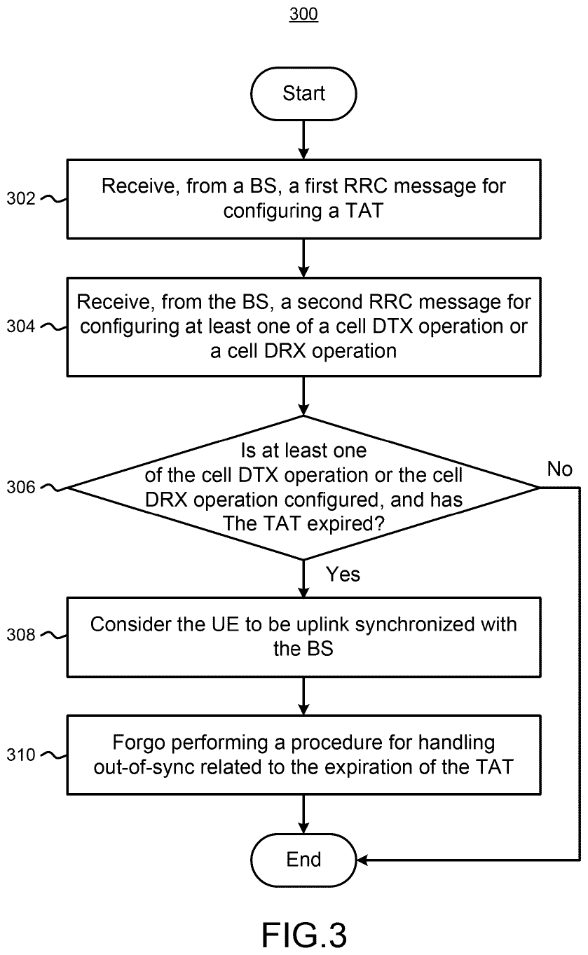

FIG. 3 is a flowchart illustrating a method/process 300 performed by a UE for handling timing alignment, according to an example implementation of the present disclosure. In some implementations, the process 300 may be performed by a UE.

In action 302, the process 300 may start by receiving, from a BS, a first RRC message for configuring a TAT. In action 304, the process 300 may receive, from the BS, a second RRC message for configuring at least one of a cell DTX operation or a cell DRX operation. In action 306, the process 300 may determine whether at least one of the cell DTX operation or the cell DRX operation is configured and whether the TAT has expired. Action 308 and action 310 may be performed in a case that at least one of the cell DTX operation or the cell DRX operation is configured and the TAT expires. In action 308, the process 300 may consider the UE to be uplink synchronized with the BS. In action 310, the process 300 may forgo performing a procedure for handling an out-of-sync condition related to the expiration of the TAT. The process 300 may then end.

In some implementations, when the cell-DTX/cell-DRX is not configured, the UE may perform a procedure, as described above, for handling the out-of-sync condition upon the expiration of the TAT. When at least one of the cell DTX operation or the cell DRX operation is configured, even if the TAT expires, the UE may still consider itself to be in the uplink synchronization state and the UE may not perform the procedure for handling the out-of-sync condition related to the expiration of the TAT.

The steps/actions shown in FIG. 3 should not be construed as necessarily order dependent. The order in which the process is described is not intended to be construed as a limitation. Moreover, some of the actions shown in FIG. 3 may be omitted in some implementations and one or more actions shown in FIG. 3 may be combined.

The technical problem addressed by the method illustrated in FIG. 3 is how to handle timing alignment under the NES scheme, such as the cell-DTX/cell-DRX operation. Because the UE may still consider itself to be in the uplink synchronization state, even if the TAT expires, neither the UE nor the BS may need to perform recovery operations for the out-of-sync condition caused by the expiration of the TAT. This may avoid imposing a significant burden on both the UE and the BS. This method may maintain uplink synchronization without the need for additional recovery operations when the TAT expires during the cell-DTX/cell-DRX operations. This may result in improved network efficiency, reduced power consumption, and enhanced user experience. For example, forgoing to perform the procedure for handling the out-of-sync condition may reduce the signaling overhead and power consumption on both the UE side and the BS side. Users may benefit from uninterrupted services and reduced latency, as the above-described method avoids the delays and disruptions typically associated with the out-of-sync recovery procedures.

In some implementations, the procedure for handling the out-of-sync condition related to the expiration of the TAT may include flushing all the HARQ buffers for uplink transmission. In some implementations, the procedure for handling the out-of-sync condition related to the expiration of the TAT may include notifying an RRC layer of the UE to release a configured PUCCH. In some implementations, the procedure for handling the out-of-sync condition related to the expiration of the TAT includes notifying the RRC layer of the UE to release a configured SRS. In some implementations, the procedure for handling the out-of-sync condition related to the expiration of the TAT may include clearing a configured downlink assignment and a configured uplink grant. In some implementations, the procedure for handling the out-of-sync condition related to the expiration of the TAT may include clearing a PUSCH resource for semi-persistent CSI reporting.

In some implementations, the TAT may expire during the non-active period of the cell DTX operation or the cell DRX operation. In some implementations, the UE may suspend the TAT in response to a starting of the non-active period of the cell DTX operation or the cell DRX operation, and the UE may resume the TAT in response to a starting of the on-duration period of the cell DTX operation or the cell DRX operation. Because the TAT is suspended upon the start of the cell-DTX/cell-DRX non-active period, this method may prevent the TAT from expiring during the cell-DTX/cell-DRX non-active period.

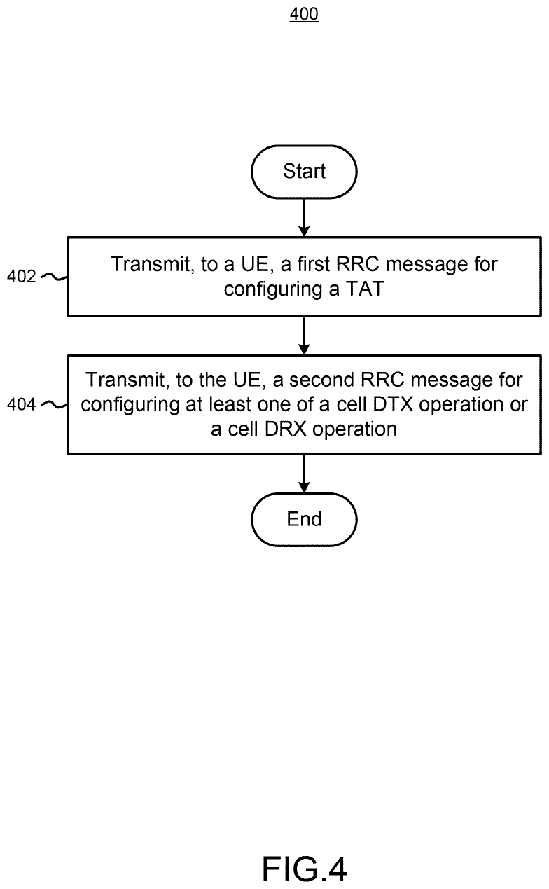

FIG. 4 is a flowchart illustrating a method/process 400 performed by a BS for handling timing alignment, according to an example implementation of the present disclosure. In some implementations, the process 400 may be performed by the BS.

In action 402, the process 400 may start by transmitting, to a UE, a first RRC message for configuring a TAT. In action 404, the process 400 may transmit, to the UE, a second RRC message for configuring at least one of a cell DTX operation or a cell DRX operation. The process 400 may then end. The method illustrated in FIG. 4 is similar to that in FIG. 3, except that it is described from the perspective of the BS (instead of the UE).

The second RRC message may enable the UE to consider the UE to be uplink synchronized with the BS and forgo performing a procedure for handling an out-of-sync condition related to the expiration of the TAT upon determining that at least one of the cell DTX operation or the cell DRX operation is configured and the TAT expires.

In some implementations, the second RRC message may further enable the UE to suspend the TAT in response to a starting of the non-active period of the cell DTX operation or the cell DRX operation and resume the TAT in response to a starting of the on-duration period of the cell DTX operation or the cell DRX operation.

In the present disclosure, implementations are disclosed regarding how a UE handles the expiration of a TAT. In some implementations, the expiration of the TAT may take place in a cell-DTX/cell-DRX non-active period. Based on the disclosed implementations, the UE may coordinate its MAC entity and RRC entity to ensure that uplink synchronization is successfully achieved before the grant for uplink transmission is scheduled during the cell-DTX/cell-DRX active period.

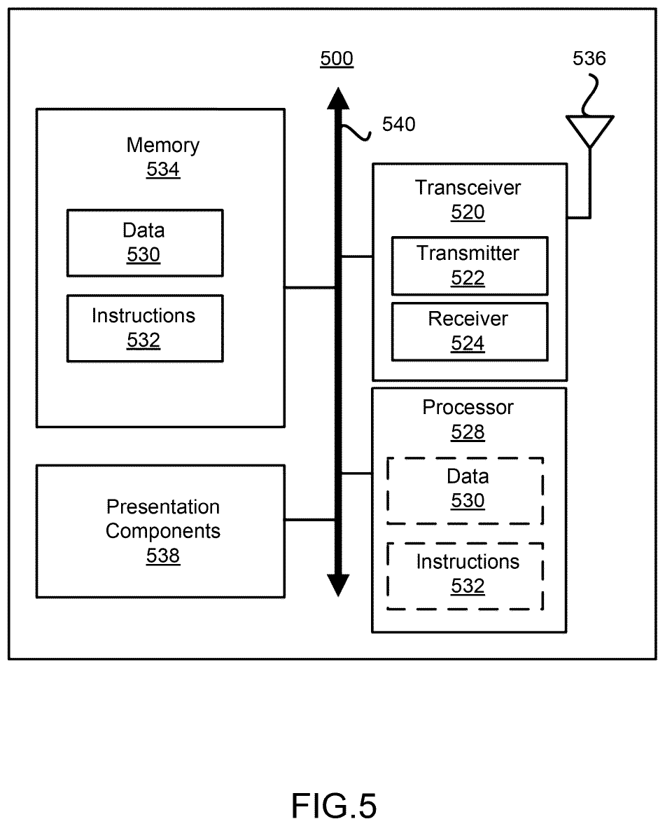

FIG. 5 is a block diagram illustrating a node 500 for wireless communication in accordance with various aspects of the present disclosure. As illustrated in FIG. 5, a node 500 may include a transceiver 520, a processor 528, a memory 534, one or more presentation components 538, and at least one antenna 536. The node 500 may also include a radio frequency (RF) spectrum band module, a BS communications module, a network communications module, and a system communications management module, Input/Output (I/O) ports, I/O components, and a power supply (not illustrated in FIG. 5).

Each of the components may directly or indirectly communicate with each other over one or more buses 540. The node 500 may be a UE or a BS that performs various functions disclosed with reference to FIGS. 1 through 4.

The transceiver 520 has a transmitter 522 (e.g., transmitting/transmission circuitry) and a receiver 524 (e.g., receiving/reception circuitry) and may be configured to transmit and/or receive time and/or frequency resource partitioning information. The transceiver 520 may be configured to transmit in different types of subframes and slots including, but not limited to, usable, non-usable, and flexibly usable subframes and slot formats. The transceiver 520 may be configured to receive data and control channels.

The node 500 may include a variety of computer-readable media. Computer-readable media may be any available media that may be accessed by the node 500 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 534 may include computer-storage media in the form of volatile and/or non-volatile memory. The memory 534 may be removable, non-removable, or a combination thereof. Example memory may include solid-state memory, hard drives, optical-disc drives, etc. As illustrated in FIG. 5, the memory 534 may store a computer-readable and/or computer-executable instructions 532 (e.g., software codes) that are configured to, when executed, cause the processor 528 to perform various functions disclosed herein, for example, with reference to FIGS. 1 through 4. Alternatively, the instructions 532 may not be directly executable by the processor 528 but may be configured to cause the node 500 (e.g., when compiled and executed) to perform various functions disclosed herein.

The processor 528 (e.g., having processing circuitry) may include an intelligent hardware device, e.g., a Central Processing Unit (CPU), a microcontroller, an ASIC, etc. The processor 528 may include memory. The processor 528 may process the data 530 and the instructions 532 received from the memory 534, and information transmitted and received via the transceiver 520, the baseband communications module, and/or the network communications module. The processor 528 may also process information to send to the transceiver 520 for transmission via the antenna 536 to the network communications module for transmission to a CN.

One or more presentation components 538 may present data indications to a person or another device. Examples of presentation components 538 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for handling timing alignment, the method comprising:
receiving, from a Base Station (BS), a first Radio Resource Control (RRC) message for configuring a Time Alignment Timer (TAT);
receiving, from the BS, a second RRC message for configuring at least one of a cell Discontinuous Transmission (DTX) operation or a cell Discontinuous Reception (DRX) operation; and
in a case that at least one of the cell DTX operation or the cell DRX operation is configured and the TAT expires:
considering the UE to be uplink synchronized with the BS, and
forgoing performing a procedure for handling an out-of-sync condition related to the expiration of the TAT.

2. The method of claim 1, wherein the procedure for handling the out-of-sync condition related to the expiration of the TAT comprises:
flushing all Hybrid Automatic Repeat Request (HARQ) buffers for uplink transmission.

3. The method of claim 1, wherein the procedure for handling the out-of-sync condition related to the expiration of the TAT comprises:
notifying an RRC layer of the UE to release a configured Physical Uplink Control Channel (PUCCH).

4. The method of claim 1, wherein the procedure for handling the out-of-sync condition related to the expiration of the TAT comprises:
notifying an RRC layer of the UE to release a configured Sounding Reference Signal (SRS).

5. The method of claim 1, wherein the procedure for handling the out-of-sync condition related to the expiration of the TAT comprises:
clearing a configured downlink assignment and a configured uplink grant.

6. The method of claim 1, wherein the procedure for handling the out-of-sync condition related to the expiration of the TAT comprises:
clearing a Physical Uplink Shared Channel (PUSCH) resource for semi-persistent Channel State Information (CSI) reporting.

7. The method of claim 1, wherein:
the TAT expires during a non-active period of the cell DTX operation or the cell DRX operation.

8. The method of claim 1, further comprising:
suspending the TAT in response to a starting of a non-active period of the cell DTX operation or the cell DRX operation; and
resuming the TAT in response to a starting of an on-duration period of the cell DTX operation or the cell DRX operation.

9. A User Equipment (UE) for handling timing alignment, the UE comprising:
at least one processor; and
at least one non-transitory computer-readable medium coupled to the at least one processor and storing one or more computer-executable instructions that, when executed by the at least one processor, cause the UE to:
receive, from a Base Station (BS), a first Radio Resource Control (RRC) message for configuring a Time Alignment Timer (TAT);
receive, from the BS, a second RRC message for configuring at least one of a cell Discontinuous Transmission (DTX) operation or a cell Discontinuous Reception (DRX) operation; and
in a case that at least one of the cell DTX operation or the cell DRX operation is configured and the TAT expires:
consider the UE to be uplink synchronized with the BS, and
forgo performing a procedure for handling an out-of-sync condition related to the expiration of the TAT.

10. The UE of claim 9, wherein the procedure for handling the out-of-sync condition related to the expiration of the TAT comprises:
flushing all Hybrid Automatic Repeat Request (HARQ) buffers for uplink transmission.

11. The UE of claim 9, wherein the procedure for handling the out-of-sync condition related to the expiration of the TAT comprises:
notifying an RRC layer of the UE to release a configured Physical Uplink Control Channel (PUCCH).

12. The UE of claim 9, wherein the procedure for handling the out-of-sync condition related to the expiration of the TAT comprises:
notifying an RRC layer of the UE to release a configured Sounding Reference Signal (SRS).

13. The UE of claim 9, wherein the procedure for handling the out-of-sync condition related to the expiration of the TAT comprises:
clearing a configured downlink assignment and a configured uplink grant.

14. The UE of claim 9, wherein the procedure for handling the out-of-sync condition related to the expiration of the TAT comprises:
clearing a Physical Uplink Shared Channel (PUSCH) resource for semi-persistent Channel State Information (CSI) reporting.

15. The UE of claim 9, wherein:
the TAT expires during a non-active period of the cell DTX operation or the cell DRX operation.

16. The UE of claim 9, wherein the one or more computer-executable instructions, when executed by the at least one processor, further cause the UE to:
suspend the TAT in response to a starting of a non-active period of the cell DTX operation or the cell DRX operation; and
resume the TAT in response to a starting of an on-duration period of the cell DTX operation or the cell DRX operation.

17. A Base Station (BS) for handling timing alignment, the BS comprising:
at least one processor; and
at least one non-transitory computer-readable medium coupled to the at least one processor and storing one or more computer-executable instructions that, when executed by the at least one processor, cause the BS to:
transmit, to a User Equipment (UE), a first Radio Resource Control (RRC) message for configuring a Time Alignment Timer (TAT); and
transmit, to the UE, a second RRC message for configuring at least one of a cell Discontinuous Transmission (DTX) operation or a cell Discontinuous Reception (DRX) operation,
wherein the second RRC message enables the UE to:
upon determining that at least one of the cell DTX operation or the cell DRX operation is configured and that the TAT has expired:
consider the UE to be uplink synchronized with the BS, and
forgo performing a procedure for handling an out-of-sync condition related to the expiration of the TAT.

18. The BS of claim 17, wherein the procedure for handling the out-of-sync condition related to the expiration of the TAT comprises at least one of the following:
flushing, by the UE, all Hybrid Automatic Repeat Request (HARQ) buffers for uplink transmission;
notifying, by the UE, an RRC layer of the UE to release a configured Physical Uplink Control Channel (PUCCH);
notifying, by the UE, the RRC layer of the UE to release a configured Sounding Reference Signal (SRS);
clearing, by the UE, a configured downlink assignment and a configured uplink grant; and
clearing, by the UE, a Physical Uplink Shared Channel (PUSCH) resource for semi-persistent Channel State Information (CSI) reporting.

19. The BS of claim 17, wherein:
the TAT expires during a non-active period of the cell DTX operation or the cell DRX operation.

20. The BS of claim 17, wherein the second RRC message further enables the UE to:
suspend the TAT in response to a starting of a non-active period of the cell DTX operation or the cell DRX operation; and
resume the TAT in response to a starting of an on-duration period of the cell DTX operation or the cell DRX operation.
